(19) United States
(12) Patent Application Publication
(10) Pub. No.: US 2005/0141953 A1
(43) Pub. Date: Jun. 30, 2005

(54) Positioning structure for a telescopic device

(76) Inventor: Lee Chang Chuan, Nan Tou Hsien (TW)

Correspondence Address: CHARLES E. BAXLEY, ESQ., 90 JOHN STREET, THIRD FLOOR, NEW YORK, NY, 10038, US

(21) Appl. No.: 10/733,437

(22) Filed: Dec. 11, 2003

(51) Int. Cl. F16B 7/10

(52) U.S. Cl. 403/109.1; 16/429

(57) ABSTRACT

A positioning structure for a telescopic device generally comprises a pipe, a rod and locking ring, wherein the pipe is interiorly provided along the axial direction with a passage for slidably receiving the rod. On the external periphery of the rod the locking ring is defined thereon for snuggly abutting against the internal surface of the pipe, which will produce drag forces during the movement of the rod and make the movement sticky, and thus the operational noise of the telescopic device can be substantially reduced. In addition, since the annular flange of the pipe stops the locking ring, the rod is prevented from disengaging from the pipe.

### BACKGROUND OF THE INVENTION

1. Field of the Invention

The present invention relates to a telescopic device, and more particularly to a positioning structure for a telescopic device.

2. Description of the Prior Arts

A conventional telescopic device, as shown in FIG. 1, generally includes a pipe 10 and rod 20. Wherein the pipe 10 is interiorly provided along the axial direction with a passage 11, and at an end of which is defined with an annular flange 12. A first end of the rod 20 is telescopic section 21 and a second end of which is working section 22 which is bent and connected to the telescopic section 21. Furthermore, on the telescopic section 21 a locking groove 211 is defined perpendicular to the axial direction. In the locking groove 211 is respectively received a spring 212 and a locking member 213. The rod 20 is telescopically received in the passage 11 of the pipe 10, since the annular flange 12 of the pipe 10 stops the locking member 213, which prevents the disengagement of the rod 20 from the pipe 10. This kind of telescopic device seems to be practical in some ways, however there are still some disadvantages of it need to be improved:

First, the locking groove 211 has to be defined on the rod 20, and in which the spring 212 and the locking member 213 are received sequentially in order to prevent the disengagement of the rod 20 from the pipe 10. Since the locking groove 211, the spring 212 and the locking member 213 are small in size, the production and the assembly of which are not easy, as a result, the production cost will accordingly be increased.

Second, during movement of the rod 20, the only resistance between the rod 20 and the pipe 10 is the pushing force that the spring 212 pushing against the locking member 213, due to the pushing force is too weak, when the telescopic device stands upright, the extended rod 20 will automatically fall down to its original position because of gravity. So a big noise will be produced after the rod 20 struck the pipe 10.

The present invention has arisen to mitigate and/or obviate the afore-described disadvantages of the conventional positioning structure for a telescopic device.

### SUMMARY OF THE INVENTION

The primary object of the present invention is to provide a telescopic device, a rod of which is equipped with locking rings which are able to produce drag force during extension or retraction of the rod. This structure not only helps to improve the smooth operation of the telescopic device but also reduce the striking noise. In addition, the locking ring also can prevent disengagement of the rod from a pipe of the telescopic device.

In accordance with one aspect of the present invention, there is provided with a positioning structure for a telescopic device that generally comprises a pipe, a rod and locking ring, wherein the pipe is interiorly provided along the axial direction with a passage for slidably receiving the rod. On the external periphery of the rod the locking ring is defined thereon for snuggly abutting against the internal surface of the pipe, which will produce drag forces during the movement of the rod and make the movement sticky, and thus the operational noise of the telescopic device can be substantially reduced. In addition, since the annular flange of the pipe stops the locking ring, the rod is prevented from disengaging from the pipe.

The present invention will become more obvious from the following description when taken in connection with the accompanying drawings, which shows, for purpose of illustrations only, the preferred embodiment in accordance with the present invention.

### BRIEF DESCRIPTION OF THE DRAWINGS

FIG. 1 is a partial cross sectional view of a conventional telescopic device;

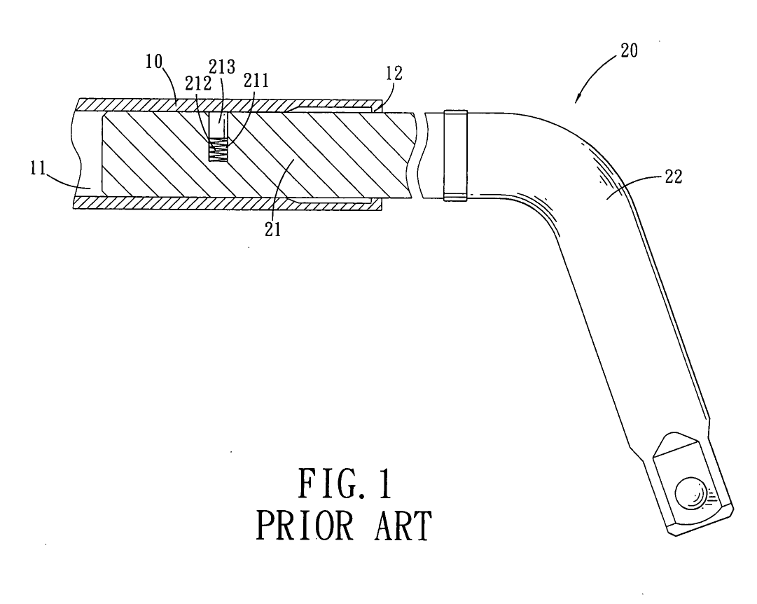

FIG. 2 is an exploded view of a telescopic device in accordance with the present invention;

FIG. 3 is a cross sectional view of the present invention of showing the rod being in the state of extending;

FIG. 4 is another cross sectional view of the present invention of showing the rod being in the state of retracting;

FIG. 5 is an exploded view of a telescopic device in accordance with another embodiment of the present invention;

FIG. 6 is an exploded view of a telescopic device in accordance with another embodiment of the present invention.

### DETAILED DESCRIPTION OF THE PREFERRED EMBODIMENTS

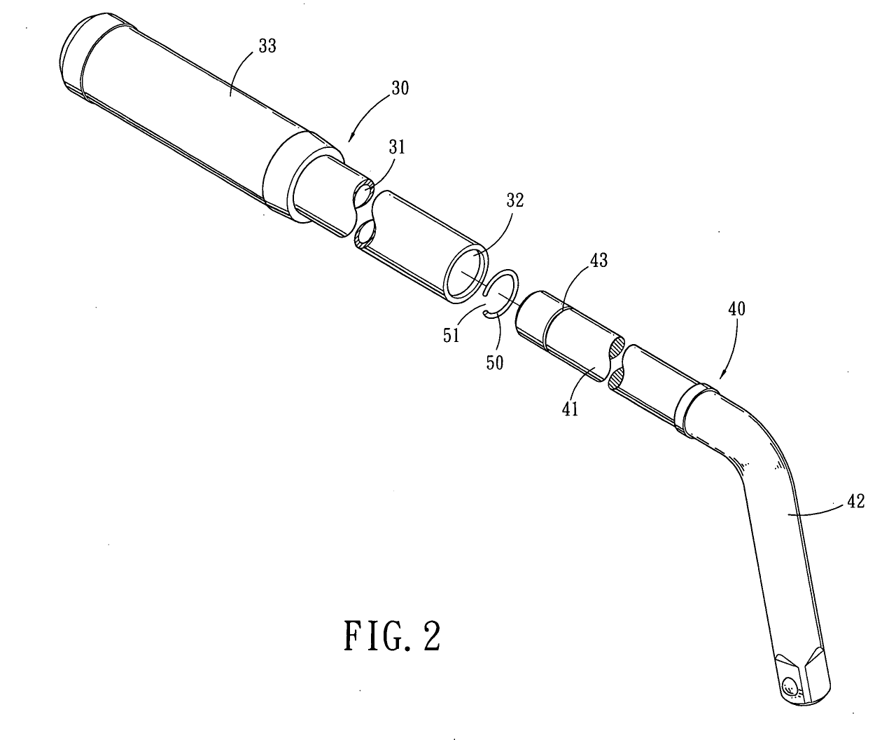

Referring to FIGS. 2-4, wherein a positioning structure for a telescopic device in accordance with the present invention is shown and generally comprised of a pipe 30, a rod 40 and a locking ring 50.

The pipe 30 is interiorly provided along the axial direction with a passage 31, at a first end of the pipe 30 is defined an annular flange 32 and at a second end of which is provided with a grip handle 33 for user's grip.

The rod 40 is slidably received in the passage 31 of the pipe 30, an end of which is a telescopic section 41, next to the telescopic section 41 is a bent working section 42. An end of the working section 42 can be used to fit different types of sleeve. Furthermore, on the rod 40 adjacent to the end of the telescopic section 41 is formed with a ring groove 43.

The locking ring 50, made of metal, is formed with a gap 51 and through which the locking ring 50 can be locked in the ring groove 43 of the rod 40. Here in this embodiment takes a C-shaped retainer ring with outward restoring force as an example. The outer periphery of the locking ring 50 abuts closely against the internal surface of the pipe 30, the locking ring 50 protrudes a little out of the ring groove 43 of the rod 40 when no pressure is applied and in compression it can be compressed into the ring groove 43.

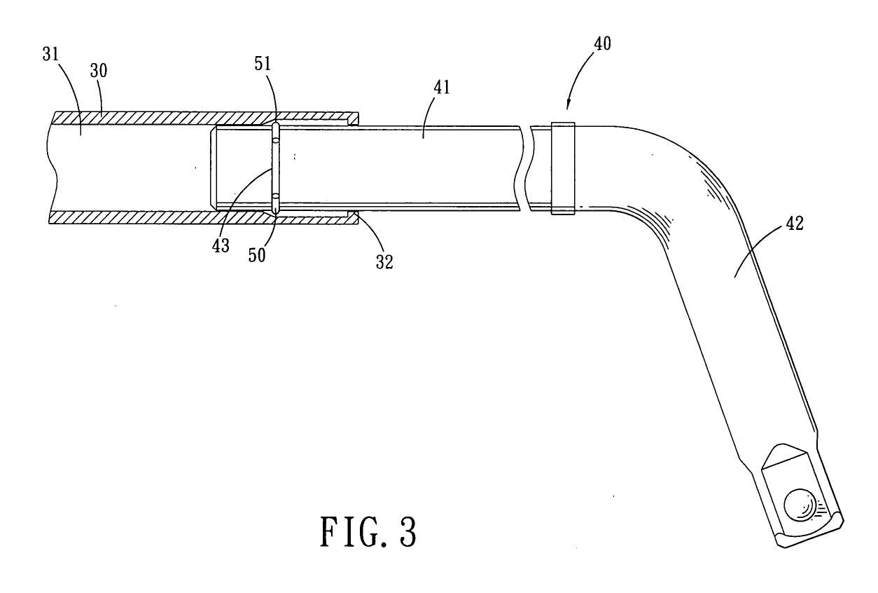

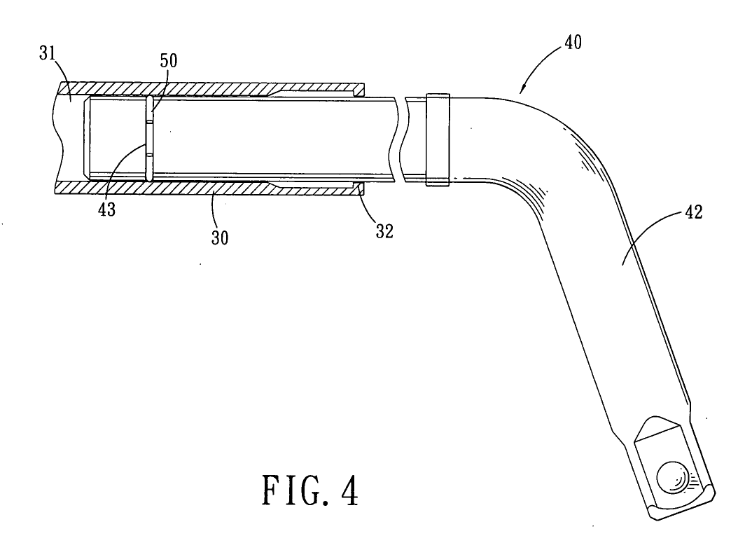

Referring to FIGS. 3 and 4, wherein the rod 40 is received in the pipe 30. The locking ring 50 closely abuts against the internal surface of the pipe 30 with its outer periphery, which will produce drag force during the movement of the rod 40 and make the rod movement sticky, but the rod 40 still can move freely. It will be noted that when the telescopic device stands upright, the drag force generated by the locking ring 50 counteracts part of gravity of the rod 40 so as to slow down the speed of the free fall of the rod 40. When the drag force is too big, the fall of the rod 40 will be stopped and the user has to push it back with his hand. In this case, the rod 40 will not strike the pipe 30 and accordingly no big noise will be caused. Moreover, in operation, when the rod 40 extends to maximum length, it will not disengage from the pipe 30 since the annular flange 32 of the pipe 30 stops the locking ring 50.

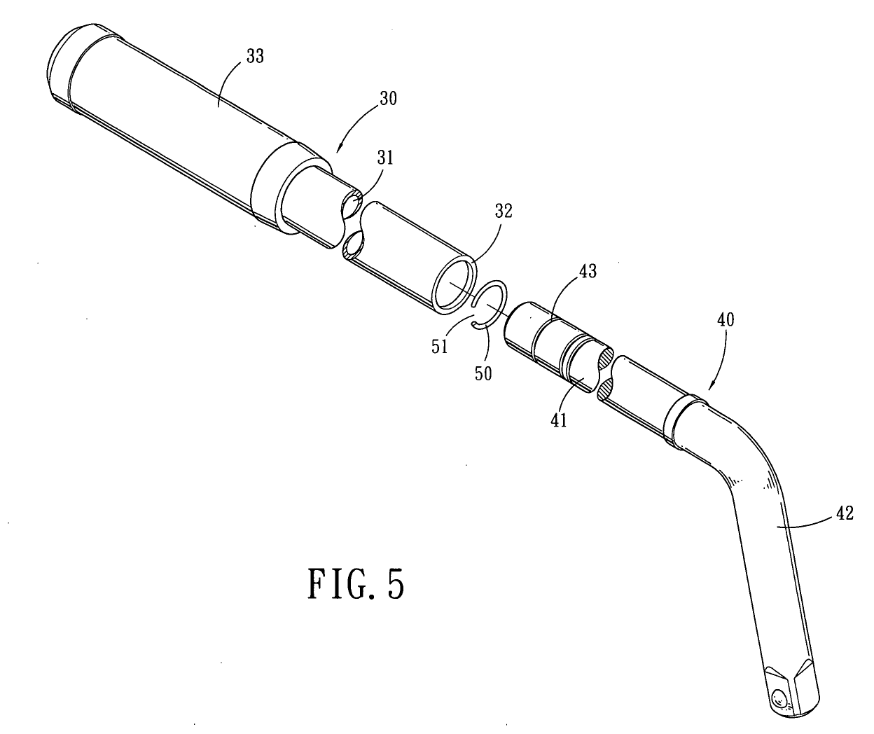

Referring to FIG. 5, to increase the drag force between the rod 40 and the pipe 30, the rod 40 can be additionally provided on the outer periphery with plural ring grooves 43, and in each of the ring grooves 43 is received a locking ring 50. In this manner, the drag force can be increased during the movement of the rod 40, and the operational noise can be reduced to the least.

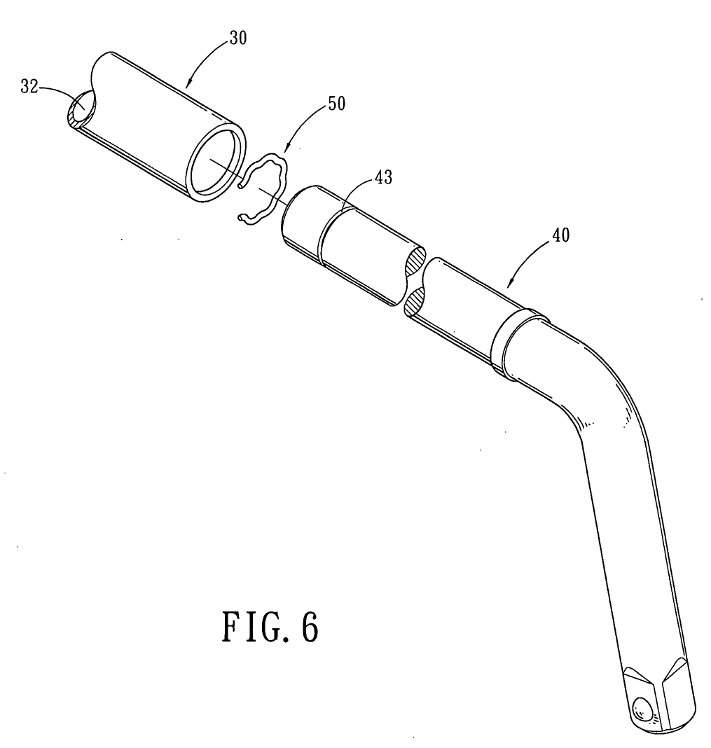

Referring to FIG. 6, wherein the locking ring 50 can be in form of wave ring, the protrusive outer periphery of the wave locking ring 50 also can abut closely against the internal surface of the pipe 30, so as to make the extension or retraction sticky.

While we have shown and described various embodiments in accordance with the present invention, it should be clear to those skilled in the art that further embodiments may be made without departing from the scope of the present invention.

1. A positioning structure for a telescopic device, comprising:
a pipe interiorly provided along the axial direction with a passage, at an end of which is defined an annular flange;
a rod slidably received in the passage of the pipe, adjacent to an end of the rod formed with a ring groove;
a locking ring, made of metal, formed with a gap and through which the locking ring can be locked in the ring groove of the rod, an outer periphery of the locking ring abutting closely against an internal surface of the pipe, so as to produce drag force during extension or retraction of the rod, the locking ring stopped by the annular flange of the pipe, whereby to prevent disengagement of the rod from the pipe.

2. The positioning structure for a telescopic device as claimed in claim 1, wherein the rod can be additionally provided on the outer periphery with plural ring grooves so as to increase the drag force between the rod and the pipe, and in each of the ring grooves a locking ring being received.

3. The positioning structure for a telescopic device as claimed in claim 1, wherein the locking ring is C-shaped retainer ring.

4. The positioning structure for a telescopic device as claimed in claim 2, wherein the locking ring is C-shaped retainer ring.

5. The positioning structure for a telescopic device as claimed in claim 1, wherein the locking ring is in form of wave-ring.

6. The positioning structure for a telescopic device as claimed in claim 2, wherein the locking ring is in form of wave-ring.
